(19) United States
(12) Patent Application Publication
(10) Pub. No.: US 2025/0346233 A1
(43) Pub. Date: Nov. 13, 2025

(54) DRIVING ASSISTANCE SYSTEM, DRIVING ASSISTANCE METHOD, AND DRIVING ASSISTANCE PROGRAM

(71) Applicant: J-QuAD DYNAMICS Inc., Tokyo (JP)

(72) Inventors: Yuki YAMAMOTO, Tokyo (JP); Koji SHIBATA, Tokyo (JP); Ryu KAMBARA, Tokyo (JP); Nobuyuki IMODA, Tokyo (JP)

(21) Appl. No.: 19/073,095

(22) Filed: Mar. 7, 2025

(30) Foreign Application Priority Data
May 9, 2024 (JP) 2024-076731

(51) Int. Cl. B60W 30/18; B60W 50/00

(52) U.S. Cl. CPC B60W 30/18163; B60W 50/0097; B60W 2050/0083; B60W 2540/18; B60W 2552/30; B60W 2554/80

(57) ABSTRACT

A driving assistance system, a driving assistance method, or a non-transitory computer-readable storage medium storing a driving assistance program for assisting driving of a host vehicle plans a lane change in the host vehicle traveling on a curved traveling road including a plurality of traveling lanes in parallel, and control the host vehicle to have a specific turning posture that keeps a different road user predicted to interact with the host vehicle within a sensing area behind the host vehicle before lane change.

### CROSS REFERENCE TO RELATED APPLICATION

The present application claims the benefit of priority from Japanese Patent Application No. 2024-076731 filed on May 9, 2024. The entire disclosure of the above application is incorporated herein by reference.

### TECHNICAL FIELD

The present disclosure relates to a driving assistance technology that assists driving a host vehicle.

### BACKGROUND

In a comparative technology, lane changes of a subject vehicle that is a host vehicle are controlled in accordance with a speed of a following vehicle among different road users.

### SUMMARY

A driving assistance system, a driving assistance method, or a non-transitory computer-readable storage medium storing a driving assistance program for assisting driving of a host vehicle plans a lane change in the host vehicle traveling on a curved traveling road including a plurality of traveling lanes in parallel, and control the host vehicle to have a specific turning posture that keeps a different road user predicted to interact with the host vehicle within a sensing area behind the host vehicle before lane change.

### BRIEF DESCRIPTION OF THE DRAWINGS

The above and other features of the present disclosure will become more apparent from the following detailed description made with reference to the accompanying drawings, in which like parts are designated by like reference numbers.

FIG. 1 is a block diagram showing a physical configuration of a driving assistance system according to an embodiment.

FIG. 2 is a schematic diagram showing a traveling environment of a host vehicle according to the embodiment.

FIG. 3 is a block diagram showing a functional configuration of a driving assistance system according to the embodiment.

FIG. 4 is a flowchart showing a driving assistance flow according to the embodiment.

FIG. 5 is a schematic diagram for illustrating the driving assistance flow according to the embodiment.

FIG. 6 is a schematic diagram for illustrating the driving assistance flow according to the embodiment.

### DETAILED DESCRIPTION

In the technology of the comparative technology, depending on a traffic state during the lane change, a blind spot would be formed by a following vehicle traveling in the traveling lane from which the lane change starts. Thereby, there is a concern that it is difficult to sense a rear vehicle traveling in the next traveling lane after the lane change. This concern becomes more noticeable when the subject vehicle is traveling on a curved traveling road, which requires the lane change, particularly, while changing its turning posture.

One example of the present disclosure provides a driving assistance system that ensures sensing of a different road user accompanying lane changes in a host vehicle. Another example of the present disclosure provides a driving assistance method that ensures sensing of the different road user accompanying the lane changes in the host vehicle. Further, another object of the present disclosure provides a driving assistance program that ensures sensing of the different road user during the lane changes in the host vehicle.

According to a first example embodiment of the present disclosure, a driving assistance system for assisting driving of a host vehicle includes a processor configured to: plan a lane change in the host vehicle traveling on a curved traveling road including a plurality of traveling lanes in parallel; and control the host vehicle to have a specific turning posture that keeps a different road user predicted to interact with the host vehicle within a sensing area behind the host vehicle before lane change.

According to a second example embodiment of the present disclosure, a driving assistance method is implemented by a processor for assisting driving of a host vehicle, and includes: planning a lane change in the host vehicle traveling on a curved traveling road including a plurality of traveling lanes; and controlling the host vehicle to have a specific turning posture that keeps a different road user predicted to interact with the host vehicle within a sensing area behind the host vehicle before lane change.

According to a third example embodiment of the present disclosure, a non-transitory computer-readable storage medium stores a driving assistance program stored in a storage medium for assisting driving of a host vehicle, the driving assistance program including instructions for causing a processor to: plan a lane change in the host vehicle traveling on a curved traveling road including a plurality of traveling lanes in parallel; and control the host vehicle to have a specific turning posture that keeps a different road user predicted to interact with the host vehicle within a sensing area behind the host vehicle before lane change.

In this way, according to the first to third example embodiments, the lane change is planned for the host vehicle traveling on the curved traveling road with multiple parallel traveling lanes. Therefore, in the first to third example embodiments, the host vehicle is controlled to have the specific turning posture. The specific turning posture keeps the different road user predicted to interact with the host vehicle within the sensing area behind the host vehicle prior to the lane change on the curved traveling road. Thereby, the host vehicle traveling on the curved traveling road is possible to start the lane change while targeting and sensing the rear different road user expected to interact with the host vehicle. Therefore, it is possible to ensure the sensing of the different road user when the host vehicle changes lanes on the curved traveling road.

Hereinafter, an embodiment of the present disclosure will be described with reference to the drawings.

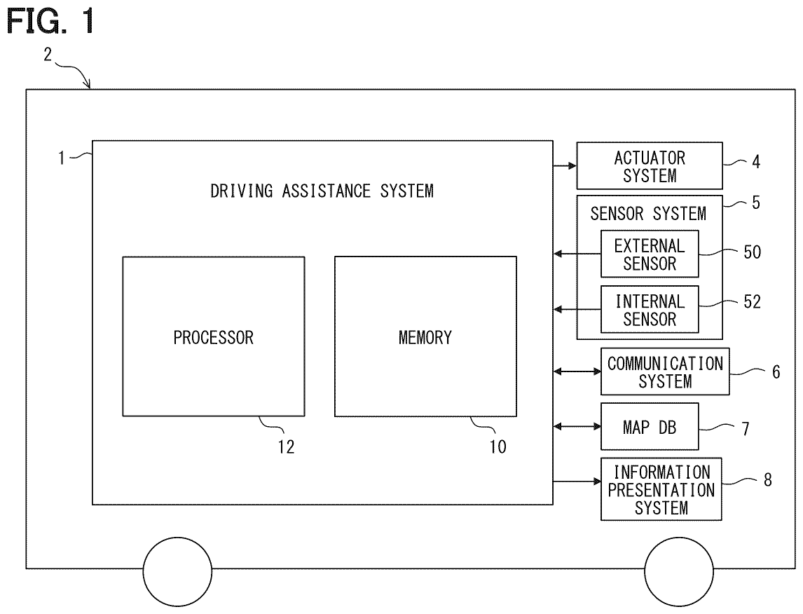

A driving assistance system 1 of an embodiment shown in FIG. 1 assists driving a host vehicle 2. At least a part of the driving assistance system 1 is installed in the host vehicle 2. The host vehicle 2 to which the driving assistance system 1 is applied may achieve a level in which there are manual driving assistance tasks that assist the operator in manual driving operations, in addition to automated driving tasks. The level is one of levels of automated driving specified in, for example, SAE J3016 and the like. The host vehicle 2 here is a road user, such as a car or truck, and may be referred to as a subject vehicle (also referred to as an ego-vehicle) from a perspective that centers the host vehicle 2. Therefore, in the driving assistance system 1 of the present embodiment, the driver who sits in the driver's seat of the host vehicle 2 and can perform manual driving operations is the target of driving assistance as the operator of the host vehicle 2.

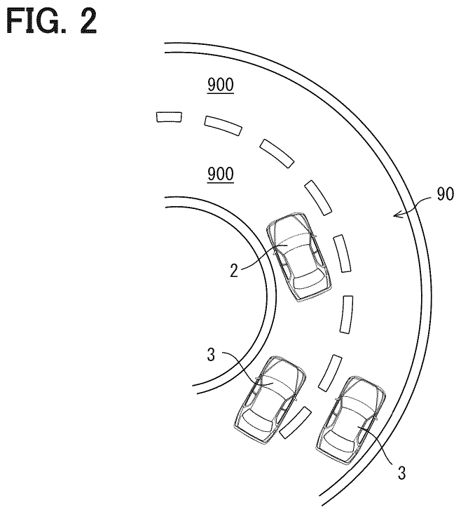

As shown in FIG. 2, in a traffic environment in which the host vehicle 2 travels, a traffic scene in which a different road user (also referred to as other road user) 3 other than the host vehicle 2 exist is assumed. The different road user 3 includes a non-vulnerable road user and a vulnerable road user according to the vulnerability. The non-vulnerable road user is at least one type of a mobile object with human occupants, such as, for example, cars, trucks, motorcycles, and bicycles. The vulnerable user is a human being, such as a pedestrian. Such the different road user 3 may be in either a stationary state or a moving state in an envisaged traffic scene.

As shown in FIG. 1, the host vehicle 2 is equipped with an actuator system 4, a sensor system 5, a communication system 6, a map database (DB) 7, and an information presentation system 8 together with at least a part of the driving assistance system 1. However, FIG. 1 representatively illustrates an example in which the entire driving assistance system 1, implemented in the form of a driving assistance device such as a processing device (for example, a processing ECU or the like) or a semiconductor device (for example, a semiconductor chip or the like), is mounted on the host vehicle 2.

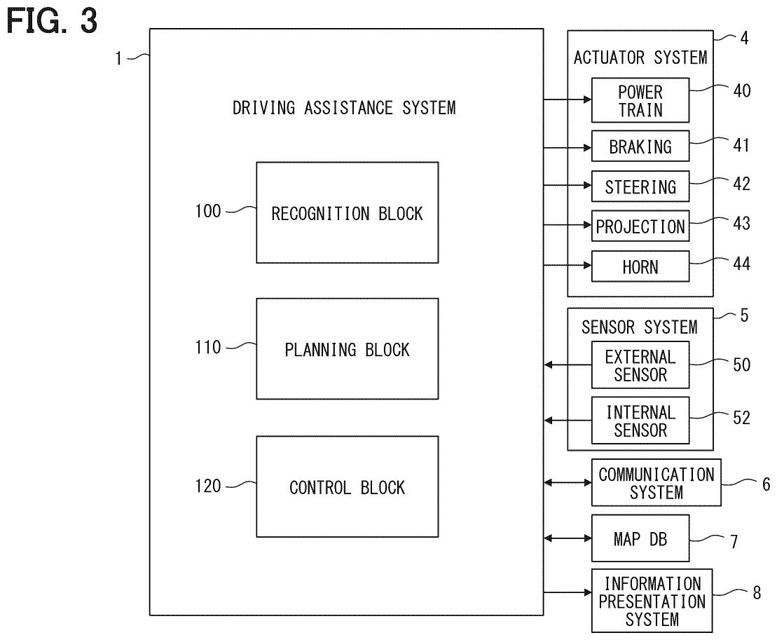

The actuator system 4 shown in FIGS. 1 and 3 is configured to control the host vehicle 2 based on a control instruction given from the driving assistance system 1. The actuator system 4 may be at least one type of powertrain actuator 40, for example, an internal combustion engine, a motor generator motor, or the like. The actuator system 4 may be at least one type of braking actuator 41, such as for example a brake unit. The actuator system 4 may be at least one type of steering actuator 42, such as a power steering unit or the like. The actuator system 4 may be at least one type of projection actuator 43, such as for example an adaptive headlight unit or a projection unit. The actuator system 4 may be at least one type of horn actuator 44, for example, such as an electronic horn unit.

The sensor system 5 senses the external and internal environments of the host vehicle 2 to acquire sensing information that can be used in the driving assistance system 1. Therefore, the sensor system 5 includes an external sensor 50 and an internal sensor 52.

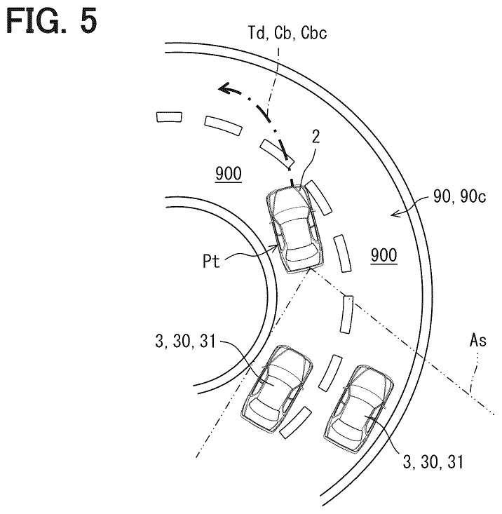

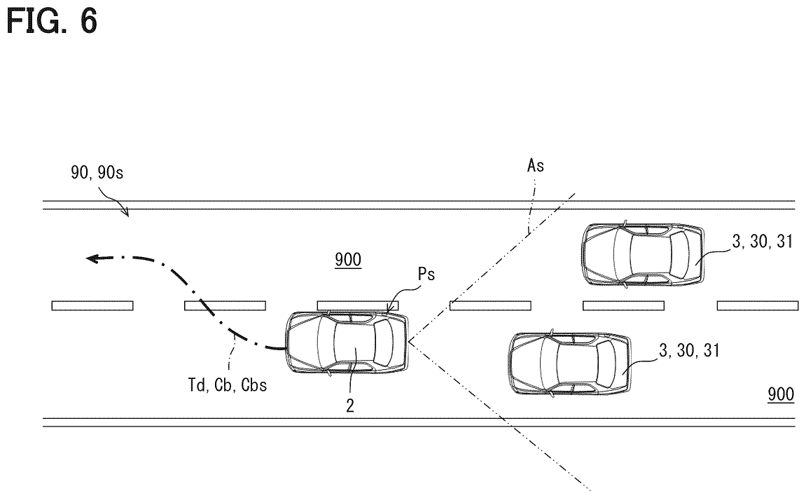

The external sensor 50 senses targets present in the external environment of the host vehicle 2. The target sensing type external sensor 50 is at least one of, for example, an in-vehicle camera, a LiDAR (light detection and ranging/laser imaging detection and ranging), a laser sensor, a millimeter wave sensor, and a sonar sensor. The target sensing type external sensor 50 may be implemented in a combination of multiple types so as to sense the front, sides, and rear directions of the host vehicle 2. In the present embodiment in particular, a sensing area As (see FIGS. 5 and 6, described later) extending rearward from the host vehicle 2 is set to a range that can be sensed by one type of external sensor 50 from among the above examples.

The internal sensor 52 senses a specific physical quantity of motion related to vehicle motion in the internal environment of the host vehicle 2. The motion sensing type internal sensor 52 is at least one of, for example, a speed sensor, an acceleration sensor, a gyro sensor, an inertial sensor, and the like. The internal sensor 52 may sense the operations or states of the occupants including the driver in the internal environment of the host vehicle 2. The occupant sensing type internal sensor 52 is at least one of, for example, an accelerator pedal sensor, a brake pedal sensor, a shift sensor, a steering angle sensor, a steering torque sensor, an occupant camera, an occupant seat switch, a gesture sensor, a biometric sensor, and a seating sensor.

The communication system 6 acquires communication information available for the driving assistance system 1 via wireless communication. The communication system 6 may receive a positioning signal from an artificial satellite of a global navigation satellite system (GNSS) present in the outside of the host vehicle 2. The positioning type communication system 6 is, for example, a GNSS receiver. The communication system 6 may transmit and receive a communication signal to and from a V2X system present in the outside of the host vehicle 2. The communication system 6 of the V2X communication type may be at least one of a dedicated short range communications (i.e., DSRC) device, a cellular V2X (i.e., C-V2X) communication device, or the like, for example. The communication system 6 may transmit and receive a communication signal to and from a mobile terminal present in the inside of the host vehicle 2. The terminal communication type communication system 6 is at least one of, for example, a Bluetooth (registered trademark) device, a Wi-Fi (registered trademark) device, and an infrared communication device.

The map DB 7 stores map information available for the driving assistance system 1. The map DB 7 includes at least one non-transitory tangible storage medium among, for example, a semiconductor memory, a magnetic medium, and an optical medium. The map DB 7 may be a DB for a locator that estimates the self-position of the host vehicle 2. The map DB may be a DB of a navigation unit that navigates the traveling route of the host vehicle 2. The map DB 7 may be constructed by a combination of multiple DBs.

The map DB 7 downloads digital maps as needed, for example, by V2X communication with an external center via the communication system 6, and updates the map information. The map information is converted into two-dimensional or three-dimensional data as information representing the external environment in which the host vehicle 2 is traveling. As the three-dimensional map information, digital data of a high precision map may be used. The map information includes road information indicating at least one of a position, a shape, or a size of a road. The map information may include structure information that indicates at least one of, for example, the positions, shapes, sizes, or the like of buildings and traffic lights facing the road. The map information may include road marking information that indicates at least one of the positions, shapes, or sizes of signs and dividing lines attached to the road.

The information presentation system 8 presents notification information to occupants including the driver of the host vehicle 2. The information presentation system 8 presents notification information to the occupants of the host vehicle 2 by stimulating their visual senses. The visual information presentation type information presentation system 8 is at least one of, for example, an in-vehicle monitor, a head-up display (HUD), a combination meter, a navigation unit, an illumination unit, or the like. The information presentation system 8 may present notification information by stimulating the occupant's auditory. The auditory information presentation type information presentation system 8 is, for example, at least one of a speaker, a buzzer, a vibration unit, and the like. The information presentation system 8 may present the notification information by stimulating the occupant's skin sensibility. The information presentation system 8 having a skin sensibility information presentation type is at least one of, for example, a vibration unit, a reaction force unit, or an air conditioning unit.

The driving assistance system 1 is connected to the actuator system 4, the sensor system 5, the communication system 6, the map DB 7, and the information presentation system 8 via at least one of a LAN (Local Area Network), a wire harness, an internal bus, a wireless communication line, and the like. The driving assistance system 1 includes at least one dedicated computer.

The dedicated computer that configures the driving assistance system 1 may be an integrated Electronic Control Unit (ECU) that integrally controls the driving of the host vehicle 2. The dedicated computer constituting the driving assistance system 1 may be a sensing ECU that processes sensing information in driving control of the host vehicle 2. The dedicated computer that constitutes the driving assistance system 1 may be a recognition ECU that recognizes the external environment in driving control of the host vehicle 2. The dedicated computer that configures the driving assistance system 1 may be a locator ECU that estimates the self-position of the host vehicle 2.

The dedicated computer constituting the driving assistance system 1 may be a planning ECU that plans driving control of the host vehicle 2. The dedicated computer constituting the driving assistance system 1 may be a navigation ECU that navigates a traveling route in driving control of the host vehicle 2. The dedicated computer constituting the driving assistance system 1 may be an actuator ECU that controls the actuator system 4 as part of driving control of the host vehicle 2.

The dedicated computer constituting the driving assistance system 1 may be an information management ECU that controls the information presentation system 8 as part of driving control of the host vehicle 2. The dedicated computer constituting the driving assistance system 1 may be at least one external computer that constructs an external center or a mobile terminal capable of communicating via, for example, the communication system 6.

The dedicated computer constituting the driving assistance system 1 includes at least one memory 10 and at least one processor 12. The memory 10 is at least one type of non-transitory tangible storage medium of, for example, a semiconductor memory, a magnetic medium, and an optical medium, for non-transitory storage of computer readable programs, data, and the like. The processor 12 includes, as a core, at least one of, for example, a CPU (Central Processing Unit), a GPU (Graphics Processing Unit), an RISC (Reduced Instruction Set Computer) CPU, and the like.

The processor 12 executes multiple instructions included in a driving assistance program stored in the memory 10 as software. As a result, the driving assistance system 1 constructs multiple functional blocks for executing the driving assistance process for the host vehicle 2. The multiple functional blocks thus constructed by the driving assistance system 1 include a recognition block 100, a planning block 110, and a control block 120, as shown in FIG. 3.

The recognition block 100 acquires sensing information from the sensor system 5. The recognition block 100 acquires communication information from the communication system 6. The recognition block 100 acquires map information stored in the map DB 7. The recognition block 100 acquires from the memory 10 past information on control instructions by the control block 120 to the host vehicle 2. The recognition block 100 processes these acquired information individually and then fuses them to recognize the state of the external and internal environments for each traveling scene of the host vehicle 2, and generates recognition data.

Specifically, the recognition block 100 generates recognition data by localization that recognizes the self-state including the self-position of the host vehicle 2. The recognition data regarding the own state may represent at least one type of its self-position (longitude and latitude and altitude), attitude angle, steering angle, speed, acceleration, jerk, and yaw rate of the host vehicle 2 in response to the control instructions in the control block 120.

The recognition block 100 generates recognition data by recognizing targets including the different road user 3, obstacles, and structures that exist in the external environment of the host vehicle 2. The recognition data regarding the target may represent at least one type of physical quantity of motion among, for example, a separation distance, a direction of motion, a relative velocity, a relative acceleration, or a time to collision. The recognition data for the targets may represent classifications of targets clustered based on their motion physics.

The recognition block 100 generates recognition data by recognizing the road on which the host vehicle 2 is traveling. The recognition data related to the road may represent at least one type of road structure. In particular, the road-related recognition data may represent at least one type of road structure, such as the number, position, width, length, shape, curvature, curve radius, and nodes, of traveling lanes 900 (see FIGS. 2, 5, 6) that constitute a traveling road 90 of the general road on which the host vehicle 2 and the different road user 3 travel.

The recognition block 100 generates recognition data by recognizing road markings associated with the road along which the host vehicle 2 travels. The recognition data regarding road markings may represent at least one type of marking state among road signs, dividing lines, and traffic lights, for example. The recognition data on road markings may further represent at least one of, for example, direction of travel, speed limit, or stopping positions that are the traffic rules recognized from the marking states. Based on these, in particular, it is preferable that the recognition data related to the traveling road 90 on general road (see FIGS. 2, 5 and 6) includes identification data for identifying the traveling lane 900 in which the host vehicle 2 and the different road user 3 are respectively traveling.

In addition to the above, the recognition block 100 generates recognition data by recognizing the actions of the driver as an operator with respect to the host vehicle 2. In particular, the recognition data related to the driver operation that provides a manual driving assistance task to the host vehicle 2 may represent at least one of, for example, accelerator pedal operation amount, brake pedal operation amount, shift position, steering angle, or steering torque. In addition, the recognition data related to the driver operation to switch the driving task provided to the host vehicle 2 between an automated driving task and a manual driving assistance task may represent the operation state of at least one type of passenger seat switch, such as a task switching switch and an assist switch, for example.

The planning block 110 shown in FIG. 3 acquires the recognition data from the recognition block 100. The planning block 110 acquires past information on control instructions to the host vehicle 2 by reading it from the memory 10. Based on the acquired data and information, the planning block 110 plans a target driving trajectory Td (see FIGS. 5 and 6) for the future travel of the host vehicle 2.

The driving trajectory Td specifies the time series changes in the motion parameters targeted as the self-state of the host vehicle 2 for each control period expected in the future beyond the present. Specifically, the driving trajectory Td may represent the position coordinates of the path that the host vehicle 2 is to follow in the future for each control period. Furthermore, the driving trajectory Td may represent at least one type of motion physical quantity, such as speed, acceleration, jerk, yaw rate, and yaw angle, as a motion parameter to be generated for each control period on such a trajectory, for example.

The control block 120 shown in FIG. 3 acquires the recognition data from the recognition block 100. The control block 120 acquires data of the driving trajectory Td from the planning block 110. The control block 120 acquires past information on control instructions to the host vehicle 2 by reading it from the memory 10. The control block 120 generates control instructions to be set in the host vehicle 2 based on the acquired data and information. At this time, a control instruction is generated to be issued to the actuator system 4 so as to control driving behavior in accordance with the automated driving level, which is adjusted to suit the traveling scene, among the automated driving tasks and manual driving assistance tasks in the host vehicle 2. The control instruction data thus generated is stored in the memory 10.

Examples of control of driving behavior according to the level of automated driving include, for example, adaptive cruise control, autonomous emergency braking, lane keeping assist, and lane change assist. Therefore, the adjustment of the automated driving level may include a handover of the driving task between the driving assistance system 1 and the driver by transitioning the driving mode between the autonomous driving task and the manual driving assistance task. Such a handover may be implemented at least at one of the times of, for example, a time when a handover request is made by the driver, an entering/leaving time for the operational design domain (ODD) of the automated driving, or a time when a minimum risk manoeuvre (MRM) is required.

### (Driving Assistance Flow)

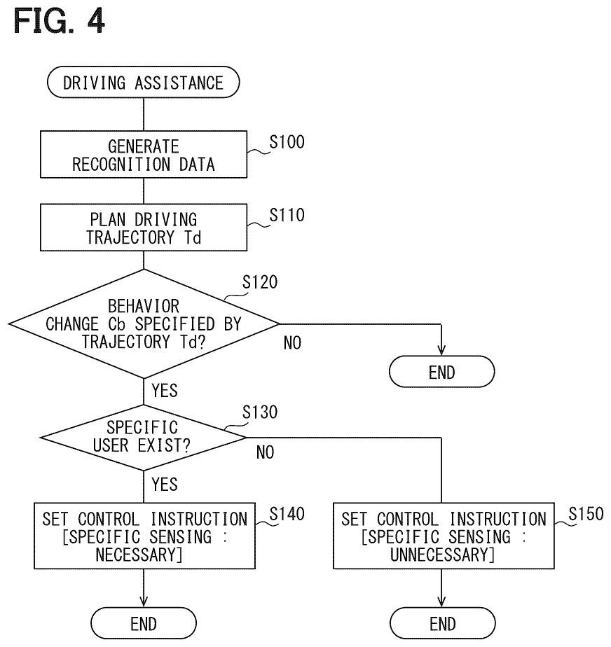

The driving assistance method in which the driving assistance system 1 controls the host vehicle 2 by cooperating with the blocks 100, 110, and 120 described above is repeatedly executed according to the driving assistance flow shown in FIG. 4. In the following description, each “S” in the driving assistance flow means multiple processes executed by multiple instructions included in the driving assistance program.

In S100, the recognition block 100 generates recognition data that recognizes the state of the external and internal environments in the current traveling scene of the host vehicle 2. In S110, the planning block 110 plans the driving trajectory Td of the host vehicle 2 from the current traveling scene to future traveling based on the recognition data (hereinafter simply referred to as recognition data) generated by at least S100 of the current flow, of the current flow and the past flow.

In S120, the control block 120 determines whether the driving trajectory Td planned in S110 of the current flow defines a specific behavior change Cb in the host vehicle 2. In this case, the specific behavior change Cb is defined as a change in driving behavior controlled by the control block 120 in the host vehicle 2, and requires the specific sensing described in detail later. Therefore, the specific behavior change Cb may occur, for example, in response to a transition from a manual driving assistance task to an automated driving task in response to the operation of a task switching switch or an assist switch, or in response to a change in the automated driving task related to driving behavior.

Specifically, the specific behavioral change Cb may be a lane change Cbc in which the host vehicle 2 moves from the traveling lane 900 in which it is currently traveling to another traveling lane 900 on a curved traveling road 90c with multiple parallel traveling lanes 900 in the traveling road 90 of the general road as shown in FIG. 5. The specific behavioral change Cb may be a lane change Cbs in which the host vehicle 2 moves from the traveling lane 900 in which it is currently traveling to another traveling lane 900 on a straight traveling road 90s with multiple parallel traveling lanes 900 in the traveling road 90 of the general road as shown in FIG. 6. Here, a traveling road 90 that extends within a curvature range that can be assumed to have a curvature of substantially zero, for example, 1/1500 or less (the unit of curvature is 1/m), is defined as the straight traveling road 90s, and a traveling road 90 that curves outside of this curvature range is defined as the curved traveling road 90c.

As shown in FIG. 4, when a negative determination is made in S120, the current flow ends. On the other hand, when a positive determination is made in S120, the current flow proceeds to S130. In S130, the control block 120 determines whether a specific user 30 exists in accordance with the specific behavior change Cb confirmed in S120 of the current flow. The specific user is the different road user 3 predicted to interact with the host vehicle 2. At this time, the presence or absence of the specific user 30 is determined based on the recognition data.

Specifically, when the specific behavior change Cb is a lane change Cbc on the curved traveling road 90c shown in FIG. 5, the presence or absence of a rear user 31 traveling along the curved behind the host vehicle 2 is determined as the specific user 30. In this case, the rear user 31 may be at least another vehicle that travels in an adjacent traveling lane 900 different from the host vehicle 2 and travels along the curve within a set distance behind the host vehicle 2. The rear user 31 may be another vehicle traveling along the curve in the traveling lane 900 common to the host vehicle 2 within a set distance behind the host vehicle 2.

When the specific behavior change Cb is a lane change Cbc on the straight traveling road 90s shown in FIG. 6, the presence or absence of the rear user 31 traveling straight behind the host vehicle 2 is determined as the specific user 30. In this case, the rear user 31 may be at least another vehicle that travels in the traveling lane 900 different from the host vehicle 2 and travels straight within a set distance behind the host vehicle 2. The rear user 31 may be another vehicle traveling straight in the traveling lane 900 common to the host vehicle 2 within a set distance behind the host vehicle 2.

As shown in FIG. 4, when a positive determination is made in S130, the current flow proceeds to S140. In S140, the control block 120 sets a control instruction indicating the specific behavior change Cb confirmed in S120 of the current flow. At this time, the control instruction may be set to control at least two types of coordination among acceleration by the powertrain actuator 40, braking (i.e., deceleration) by the braking actuator 41, and steering by the steering actuator 42.

Specifically, when the specific behavioral change Cb is the lane change Cbc on the curved traveling road 90c as shown in FIG. 5, the control instruction is set so that the rear user 31 traveling in the adjacent traveling lane 900 different from the host vehicle 2 is targeted for sensing as the specific user 30. Therefore, the control instruction is an instruction indicating a specific turning posture Pt in order to perform specific sensing to contain the rear user 31 traveling in the adjacent traveling lane 900 within the sensing area As rearward from the host vehicle 2 prior to the lane change Cbc on the curved traveling road 90c. At this time, the control instruction is preferably set to specify the specific turning posture Pt at a traveling position toward the traveling lane 900 of the destination lane change in the width direction of the curved traveling road 90c in the traveling lane 900 where the lane change starts. Based on these, particularly on the curved traveling road 90c, the specific turning posture Pt is controlled by coordinating at least two of the above-described acceleration, braking, and steering. Thereby, it is possible to achieve both curve traveling and lane change Cbc while sensing the rear user 31.

Here, the driving trajectory Td planned by S110 of the current flow is assumed to specify the lane change Cbc from the traveling lane 900 of the inside part in the curved area of the curved traveling road 90c to the traveling lane 900 of the outside part of the same road 90c, as shown in FIG. 5. In this assumed case, in S140, which is reached upon a positive determination in S130, a control instruction is set to restrict the host vehicle 2 from changing the specific turning posture Pt in the traveling lane 900 where the lane change starts, in response to the entering to the traveling lane 900 that is the lane change destination. At this time, the control instruction is set to instruct the steering actuator 42 to adjust the steering angle to steer from, for example, a state shown in FIG. 2 toward the lane change destination traveling lane 900 opposite to the curve side in the traveling lane 900 where the lane change starts. Thereby, the appropriate specific turning posture Pt in FIG. 5. The change in the posture Pt is restricted. As a result of such a control instruction, the amount of change in the steering angle until the host vehicle 2 enters the traveling lane 900 after the lane change is limited within an allowable range. Thereby, it is possible to complete the lane change Cbs while stabilizing the specific turning posture Pt.

When the specific behavior change Cb is the lane change Cbs on the straight traveling road 90s shown in FIG. 6, a control instruction is set so that the sensing target is the rear user 31 as the specific user 30 traveling in an adjacent traveling lane 900 different from the host vehicle 2. At this time, the control instruction indicates a specific traveling position Ps to perform specific sensing to capture the rear user 31 traveling in the adjacent traveling lane 900 within the sensing area As rearward from the host vehicle 2 prior to the lane change Cbc on the straight traveling road 90s. Therefore, in response to the rear user 31 entering within the rear sensing area As, the control instruction should be set to specify the specific traveling position Ps toward the traveling lane 900 of the destination lane change in the width direction of the straight traveling road 90s, in the traveling lane 900 where the lane change starts. By setting such control instructions, on the straight traveling road 90s, it is possible to complete the lane change Cbs while stabilizing the posture of the host vehicle 2 at the specific traveling position Ps by coordinated control of at least two types of acceleration, braking, or steering as described above.

As shown in FIG. 4, when a negative determination is made in S130, the current flow proceeds to S150. In S150, the control block 120 sets a control instruction indicating the specific behavior change Cb confirmed in S120 of the current flow. At this time, specific sensing for keeping the rear user 31, whose presence has not been confirmed, within the sensing area As is not necessary. Therefore, a control instruction equivalent to S140 is set, excluding the specific sensing.

In S140 and S150 described above, along with the control instruction indicating the specific behavior change Cb, a control instruction for notifying the different road user 3 of the specific behavior change Cb by projection on the traveling road 90 from the projection actuator 43 may be set. In S140 and S150, along with the control instruction indicating the specific behavior change Cb, a control instruction for notifying the different road user 3 of the specific behavior change Cb by a warning sound from the horn actuator 44 may be set. After the execution of either S140 or S150 is completed, the current flow ends.

### (Operation and Effects)

The operation and effects in the present embodiment described above will be described below.

According to the present embodiment, the lane change Cbc is planned for the host vehicle 2 traveling on the curved traveling road 90c on which multiple traveling lanes 900 are arranged in parallel. Therefore, in the present embodiment, the host vehicle 2 is controlled to have the specific turning posture Pt. The specific turning posture Pt keeps the different road user 3 predicted to interact with the host vehicle 2 within the sensing area As behind the host vehicle 2 prior to the lane change Cbc on the curved traveling road 90c. Thereby, the host vehicle traveling on the curved traveling road 90c is possible to start the lane change Cbc while targeting and sensing the rear different road user 3 (rear user 31 in the present embodiment) expected to interact with the host vehicle 2. Therefore, it is possible to ensure sensing of other road users 3 when the host vehicle 2 makes the lane change Cbc on the curved traveling road 90c.

According to the present embodiment, the control instruction is set in the host vehicle 2 so as to define the specific turning posture Pt at a traveling position toward the traveling lane 900 of the lane change destination in the traveling lane 900 where the lane change starts. As a result, when the rear different road user 3 is predicted to interact with, in the traveling lane 900 that is the lane change destination, the host vehicle 2 traveling on the curved traveling road 90c, the sensing area AS easily covers the different road user 3 before the start of lane change Cbc in the traveling lane 900 where the lane change starts. Therefore, it is possible to improve the effect of ensuring sensing of the different road user 3 in the host vehicle 2 when the lane change Cbc occurs on the curved traveling road 90c.

According to the present embodiment, the lane change Cbc from the inner traveling lane 900 to the outer traveling lane 900 on the curved traveling road 90c is planned. Therefore, the control instruction is set in the host vehicle 2 to restrict the change in the specific turning posture Pt when the host vehicle 2 enters the traveling lane 900 after the lane change. As a result, the host vehicle 2 traveling on the curved traveling road 90c can proceed with the lane change Cbc while maintaining the sensing state aimed at the rear different road user 3 predicted to interact with the host vehicle 2. Therefore, it is possible to improve the effect of ensuring sensing of the different road user 3 in the host vehicle 2 when the lane change Cbc occurs on the curved traveling road 90c.

According to this embodiment, the control instruction is set in the host vehicle 2 to restrict the change in the specific turning posture Pt defined by adjusting the steering angle in the traveling lane 900 of the lane change destination toward the traveling lane 900 of the lane change destination. As a result, when the rear different road user 3 is predicted to interact with, in the traveling lane 900 that is the lane change destination, the host vehicle 2 traveling on the curved traveling road 90c, the host vehicle 2 can proceed with the lane change Cbc while the sensing area AS covers the different road user 3 from the traveling lane 900 where the lane change starts Therefore, it is possible to stabilize the specific turning posture Pt for ensuring sensing of the different road user 3 related to the lane change Cbc in the host vehicle 2. Thereby, it is possible to improve the safety of the host vehicle 2.

According to the present embodiment, the control instruction is set to control the specific turning posture Pt by coordinating acceleration, steering, and braking. Thereby, the host vehicle 2 is possible to sequentially implement the specific turning posture Pt that achieves both the curve traveling on the curved traveling road 90c and the lane change Cbc while targeting and sensing the different road user 3 for the interaction prediction through such coordinated control. Therefore, it is possible to improve the effect of ensuring the sensing of the different road user 3 related lane change Cbc in the host vehicle 2.

According to the present embodiment, the lane change Cbs is planned for the host vehicle 2 traveling on the straight traveling road 90s on which multiple traveling lanes 900 are arranged in parallel. In response to the state where the different road user 3 is within the sensing area As behind the host vehicle 2, the host vehicle 2 is controlled to, in the traveling lane 900 where the lane change starts, the specific traveling position Ps toward the traveling lane 900 that is the lane change destination. As a result, even when the host vehicle 2 is traveling on the straight traveling road 90s and is predicted to interact with the rear different road user 3 (in the present embodiment, the rear user 31) in the traveling lane 900 that is the lane change destination, it is possible to travel while keeping the rear user 31 within the sensing area As in the traveling lane 900 where the lane change starts, even before the start of the lane change Cbs. Therefore, it is possible to extend the effect of ensuring the sensing of the different road users 3 related to the lane changes Cbs in the host vehicle 2 to the straight traveling as well as the curve traveling.

### OTHER EMBODIMENTS

Although one embodiment has been described above, the present disclosure is not to be construed as being limited to the embodiment of the description, and can be applied to various embodiments within the scope not departing from the gist of the present disclosure.

In a modification, a dedicated computer constituting the driving assistance system 1 may include at least one of a digital circuit or an analog circuit, as a processor. The digital circuit is at least one type of, for example, an application specific integrated circuit (i.e., ASIC), a field programmable gate array (i.e., FPGA), a system on a chip (i.e., SOC), a programmable gate array (i.e., PGA), a complex programmable logic device (i.e., CPLD), and the like. Such a digital circuit may also include a memory in which a program is stored.

In the modification, the operator who manually drives the host vehicle 2 to which the driving assistance system 1 is applied may be a remote operator who remotely controls the driving of the host vehicle 2 from an external center. In the modification, the driving assistance system 1 may be configured to implement only automated driving tasks, without the existence of manual driving assistance tasks that assists the operator in performing manual driving operations.

What is claimed is:

1. A driving assistance system for assisting driving of a host vehicle, the system comprising
a processor configured to:
plan a lane change in the host vehicle traveling on a curved traveling road including a plurality of traveling lanes in parallel; and
control the host vehicle to have a specific turning posture that keeps a different road user predicted to interact with the host vehicle within a sensing area behind the host vehicle before lane change.

2. The driving assistance system according to claim 1, wherein
the plurality of traveling lanes include a lane change start traveling lane and a lane change destination traveling lane, and
control of the host vehicle includes a setting of a control instruction in the host vehicle to specify, in the lane change start traveling lane, the specific turning posture at a traveling position toward the lane change destination traveling lane.

3. The driving assistance system according to claim 1, wherein
a plan of the lane change includes a plan of the lane change from, among the plurality of lane changes, an inter traveling lane to an outer traveling lane on the curved traveling road, and
control of the host vehicle includes a setting, in the host vehicle, of a control instruction for restricting a change in the specific turning posture when the host vehicle enters a lane change destination traveling lane among the plurality of traveling lanes.

4. The driving assistance system according to claim 3, wherein
the plurality of traveling lanes include a lane change start traveling lane and the lane change destination traveling lane,
the control of the host vehicle includes a setting a control instruction in the host vehicle to restrict a change in the specific turning posture defined by a steering angle adjustment in the lane change start traveling lane, and
the steering angle adjustment is performed toward the lane change destination traveling lane.

5. The driving assistance system according to claim 1, wherein
control of the host vehicle includes a setting of, in the host vehicle, a control instruction to control the specific turning posture by coordination of acceleration, steering, and braking.

6. The driving assistance system according to claim 1, wherein
a plan of the lane change includes a plan of the lane change in the host vehicle traveling on a straight road including the plurality of traveling lanes in parallel,
the plurality of traveling lanes include a lane change start traveling lane and a lane change destination traveling lane, and
control of the host vehicle includes control of the host vehicle to, in the lane change start traveling lane, a specific traveling position toward the lane change destination traveling lane in response to the different road user within the sensing area behind the host vehicle.

7. A driving assistance method that is implemented by a processor for assisting driving of a host vehicle, the method comprising:
planning a lane change in the host vehicle traveling on a curved traveling road including a plurality of traveling lanes; and
controlling the host vehicle to have a specific turning posture that keeps a different road user predicted to interact with the host vehicle within a sensing area behind the host vehicle before lane change.

8. A non-transitory computer-readable storage medium storing a driving assistance program for assisting driving of a host vehicle, the driving assistance program including instructions for causing a processor to:
plan a lane change in the host vehicle traveling on a curved traveling road including a plurality of traveling lanes; and
control the host vehicle to have a specific turning posture that keeps a different road user predicted to interact with the host vehicle within a sensing area behind the host vehicle before lane change.
